(19) United States
(12) Patent Application Publication
(10) Pub. No.: US 2023/0269465 A1
(43) Pub. Date: Aug. 24, 2023

(54) ELECTRONIC CAMERA

(71) Applicant: Arnold & Richter Cine Technik GmbH & Co. Betriebs KG, Munchen (DE)

(72) Inventors: Hermann POPP, München (DE); Frank ZEIDLER, München (DE); Alexander MANN, München (DE); Michael HAUBMANN, Wien (AT)

(21) Appl. No.: 18/113,738

(22) Filed: Feb. 24, 2023

(30) Foreign Application Priority Data
Feb. 24, 2022 (DE) 10 2022 104 409.2

(51) Int. Cl. H04N 23/661; H04N 23/50

(52) U.S. Cl. CPC H04N 23/661; H04N 23/50

(57) ABSTRACT

The invention relates to a modular electronic camera, and in particular a distributed electronic camera, comprising an image acquisition module comprising an image sensor and an image processing unit coupled to the image sensor, an operating module for controlling and/or configuring the camera, and a display module for displaying camera images acquired by the image sensor, wherein the image acquisition module, the operating module and the display module are camera modules. The camera in accordance with the invention is characterized in that the image acquisition module, the operating module and the display module are connected to one another by means of a data network, with the data network having a distribution unit that is configured to receive data via the data network from the camera modules and to forward data from one of the camera modules to at least one of the other camera modules.

The present invention relates to a modular electronic camera, and in particular a distributed electronic camera, comprising an image acquisition module comprising an image sensor and an image processing unit coupled to the image sensor. The electronic camera furthermore comprises a first functional module, for example an operating module for controlling and/or configuring the camera, and a second functional module, for example a display module for displaying camera images acquired by the image sensor. The image acquisition module and the functional modules are camera modules in this respect.

In today's professional film cameras, such as are used in film and television productions, a plurality of different interfaces are in use within the camera that are used for image data, sound data, synchronization data or metadata. Today's cameras also usually comprise a plurality of external interfaces that enable the connection of external accessories.

However, the many different interfaces set limits on the flexible use or on the convertibility of the camera. Only accessories that are in each case specifically set up for the present interfaces may be used with the present interfaces. The connection of new or different accessories or a modification to the internal hardware of the camera usually requires a firmware adaptation and/or a software adaptation in order, for example, to adapt the camera to new interfaces, new protocols and the like.

It is therefore the underlying object of the invention to specify an electronic camera that may be flexibly set up or converted and changed.

This object is satisfied by an electronic camera in accordance with claim 1.

The camera in accordance with the invention is characterized in that the image acquisition module and the first and second functional module (i.e., for example, the operating module and the display module) are connected to one another by means of a data network (in particular the same data network), with the data network having a distribution unit that is configured to receive data via the data network from the camera modules and to forward data from one of the camera modules to at least one of the other camera modules.

The functional modules in particular serve to provide a respective portion of the functions of the camera.

The camera modules may each be directly and/or separately coupled to the distribution unit. For example, provision may be made that data (e.g. at least one data stream) of a camera module are received in the distribution unit and are forwarded from the distribution unit to other camera modules.

The invention is in this respect based on the recognition that an interface of the same kind is provided for all the camera modules by means of the distribution unit by connecting the camera modules to the distribution unit via the data network. The distribution unit may, for example, be a switch in an Ethernet network, as will be explained in more detail below. Due to the communication in accordance with the invention of the camera modules via the data network, a clear modularization of the camera is provided so that the camera may generally be flexibly expanded and modified. In general, any desired functional modules and/or camera modules may be coupled to the image acquisition module via the data network in order to map different equipment variants or functions of the camera.

Advantageously, the distribution unit does not have to be able to interpret the data from all the camera modules, but may simply forward the data of the camera modules to other camera modules.

In general, the topology of the data network may be selected arbitrarily. The data network may, for example, connect the camera modules by means of a ring topology or a daisy chain topology. The distribution unit in a ring topology or daisy chain topology is then formed by the wiring of the data network and/or by the camera modules themselves. Alternatively or additionally, the data network may also comprise a star topology, for example, with a central switch or with distributed switches.

Furthermore, it is possible to replace or to reconnect internal camera modules without great effort since the camera modules, in particular all the camera modules, are coupled to the distribution unit via the data network. A change of the firmware and/or software in the camera may thereby be avoided. The same applies to externally connected camera modules. Such externally connected camera modules may be coupled to the distribution unit via the data network just like internal camera modules. In this way, it is possible to relocate camera modules externally so that the part of the camera that is carried, e.g. in the hand or on the shoulder, may be significantly smaller and thus lighter and more manageable.

Due to the invention, the camera consequently becomes more easily scalable, more modular and may be used under different requirements.

It is understood that the above-mentioned camera modules in accordance with the invention may also be replaced or supplemented by other camera modules described herein.

A camera module and/or a functional module is in particular to be understood as a functional group that performs a specific (part) function of the camera.

In the image acquisition module, an image sensor is coupled to the associated electronics, wherein the associated electronics are designated as the image processing unit here. The image processing unit may, for example, effect a power supply, a temperature stabilization and/or a cooling of the image sensor. The image processing unit may furthermore be configured to read out the camera images acquired by the image sensor and to observe a predefined timing and/or a triggering during the readout.

The image processing unit preferably converts the camera images into a digital format that may be sent via the data network. The camera images may be available as single images or as video. For example, the camera images may be transmitted as a stream via the data network.

The operating module may have a human-machine interface (HMI), for example, in the form of a touch screen or an arrangement of switches and/or a display. The operating module may, for example, serve to start or to stop the recording of camera images, to set a frame rate when recording camera images, a color depth and the like.

The display module preferably comprises a display on which e.g. the camera images currently acquired by the image acquisition module may be displayed. The display module may, for example, be a viewfinder (Electronic View Finder—EVF) or a monitor in general.

Connections, in particular all the connections, by means of the data network between the distribution unit and the camera modules are preferably an identical data network or the same data network. This means that all the connections, for example, take place via the same protocol and/or the camera modules are disposed in an associated address range of the data network.

The camera is in particular a camera for professional film recordings, in particular configured for recording moving images (videos), still images and single images and/or time lapse recordings, wherein the camera may e.g. have an exchangeable lens. The camera (or the image acquisition module) may e.g. be configured for recording image data at a resolution of at least 4K, 4.5K or 8K at frame rates of 60 FPS, 90 FPS, 100 FPS or 150 FPS.

Advantageous embodiments of the invention can be seen from the description, from the dependent claims and from the drawings.

In accordance with a first embodiment, the distribution unit comprises a network switch, a hub, a router and/or a gateway. The distribution unit may also be one of the network components mentioned. The distribution unit preferably has network ports to each of which a camera module may be connected. The ports may support different transmission speeds, for example, 10 Mbit, 100 Mbit, 1 Gbit, Gbit, 100 Gbit or 400 Gbit.

If the distribution unit is a hub, all the data arriving from the camera modules at the distribution unit will be forwarded to all the other camera modules. In the case of a switch, a router and/or a gateway, the incoming data may be forwarded in a targeted manner to specific camera modules. For this purpose, the distribution unit then includes information about which camera module is connected to which network port. By using, for example, a switch, there is thus the advantage that data intended only for a respective camera module are forwarded to this camera module by the distribution unit. The present transmission bandwidth of the data network is consequently not unnecessarily exhausted.

In accordance with a further embodiment, the distribution unit is designed in a cascaded manner and/or from part units. Therefore, the distribution unit may, for example, be “stacked” or have sub-units (“cascaded”). It is only relevant that the components of the distribution unit may communicate with one another so that a communication of the camera modules among one another is possible via the data network. Alternatively, the possibility exists of the distribution unit having only exactly one component, for example, only one switch.

In distributed and/or cascaded distribution units, it is also possible for at least some of the camera modules to each comprise a part of the distribution unit. For example, some of the camera modules may each have their own switch so that a plurality of such camera modules may be connected in a chain by means of network cables. In this respect, each camera module may, for example, have at least two network sockets.

The camera modules are in particular only connected by means of the data network with respect to the data transmission. Accordingly, additional further communication paths for data communication between the camera modules preferably do not exist since the modularity and expandability of the camera would hereby be restricted.

In accordance with a further embodiment, the distribution unit is configured to recognize camera modules connected to the distribution unit via the data network and to perform the forwarding of data of the camera modules based on the connected camera modules. As already briefly explained above, such a targeted forwarding is, for example, possible in the case of a switch, a router or a gateway. The distribution unit may, for example, recognize that data e.g. of an audio module do not have to be forwarded to the image acquisition module, but should instead only be made available to the operating module or a recording module. In this way, transmission capacity may again be saved in the data network. If data of one camera module is required by a plurality of or all of the other camera modules, the distribution unit and/or the respective transmitting camera module may use a multicast or a broadcast. The data are simultaneously transmitted to a plurality of camera modules by a multicast; the data are simultaneously transmitted to all the camera modules by a broadcast.

In accordance with a further embodiment, at least one of the camera modules, in particular after the connection to the data network, transmits a device profile via the data network, wherein the device profile comprises a device class of the camera module and information about the functional scope of the camera module. The camera adapts its operating parameters based on the transmitted device profile or the transmitted device profiles in order to integrate the transmitting camera module into the operation of the camera. In other words, the camera therefore evaluates the device profiles of the connected camera modules in order e.g. to adapt the operation of the camera to the connected camera modules and, if necessary, to optimize it to the camera modules.

For this purpose, the camera may have a control unit that evaluates the device profiles of the camera module or of the camera modules. The control unit may in each case perform and/or initiate the steps described herein. A camera module or the distribution unit may in particular perform the functions of the control unit.

The device profiles make it possible to provide a standardized data format by encapsulating and/or describing the functionalities of the camera modules by means of the device profiles, whereby a uniform format for exchanging capabilities and restrictions between the camera and the camera modules is provided. With the device profile, the camera modules in particular in each case communicate their requirements and also information about their functional scope to the camera.

Due to the transmission of the device profiles, the camera may then react sensibly to almost any camera modules and also to new camera modules without a change of the firmware and/or software of the camera being required. The development effort for integrating new and/or other accessories (i.e. camera modules) may thus be significantly reduced.

Due to the connection and the integration into the operation of the camera, the respective camera module itself becomes part of the camera. The camera module may in particular only make the camera fully functional, for example, when the camera module is a lens or an image acquisition module.

After connecting the camera modules via the data network, an exchange of the device profiles may also take place. This means that the newly connected camera module also receives the device profiles via the data network from camera modules already present in the camera. The newly connected camera module may then preferably also adapt its operation to the already present camera modules.

To integrate a newly connected camera module into the operation of the camera, the camera changes its operating parameters. The operating parameters may, for example, define the data format and/or the protocol by means of which communication with the newly connected camera module takes place via the data interface. However, the operating parameters may also, for example, comprise a frame rate and/or or a resolution of the camera images acquired by the camera. If a memory module is, for example, connected as a new camera module to the camera and at most supports a resolution of 4K at a frame rate of 60 FPS, the operating parameters may be set such that camera images with a resolution of 4K and a frame rate of 60 FPS are generated and/or are transmitted at least in this format to the memory module. In general, the operating parameters are to be understood as all the settings of the camera that may have an effect on the operation of the camera.

The device class may, for example, specify whether the camera module is an image acquisition module, a memory module or a playback module. The information about the functional scope may e.g. specify the maximum resolution, the frame rate, the color depth and the like for the image acquisition module. The storage capacity may e.g. be specified for the memory module and the playable file formats may e.g. be specified for the playback module.

Due to the device class included in the device profile, the camera may adapt its operating parameters as a fallback position e.g. to a standard device, in particular a predefined standard device, of this device class. In this way, newly developed camera modules may also be integrated into the operation of the camera even if the newly developed camera modules have functions that are not supported by the camera. In this case, at least basic functions (e.g. the functions of the standard device) may nevertheless be usable. For example, a novel distance measurement system that has a plurality of measurement points may nevertheless be used at an existing camera since it is recognized as belonging to the distance measurement system device class and e.g. also provides a value that corresponds to an existing single-point distance measurement device. In this way, a software update for existing devices may be avoided during the market launch of new camera modules.

In accordance with a further embodiment, each of the camera modules is configured as an independent network component. This means that each of the camera modules is able to communicate independently via the data network. Each camera module may be configured in terms of hardware for the communication via the data network and accordingly comprises a suitable physical interface (PHY interface). A protocol stack required for the communication via the data network may also be implemented in each camera module.

In accordance with a further embodiment, the data network comprises an Ethernet network, a fieldbus network or a non-IP network (NIN). Alternatively, the data network is one of the aforementioned networks. Ethernet, for example, defines wired data networks, with transmission rates between 1 Mbit and 400 Gbit. In an Ethernet network, both the physical layer (OSI Layer 1) and the data link layer (OSI Layer 2) are predefined. The data network may at least sectionally also be formed by a WLAN (Wireless Local Area Network). In this case, one or more camera modules and/or the distribution unit may comprise a WLAN transceiver so that camera modules may also be integrated into the data network by means of WLAN.

A fieldbus network may, for example, provide a real-time capability. The fieldbus network may alternatively or additionally be Ethernet-based. The fieldbus network may e.g. be EtherCAT, EIP, Sercos III and the like. The non-IP network (NIN) may in particular be a stream-based network instead of a packet-based network.

In accordance with a further embodiment, the distribution unit is configured to communicate with the camera modules via the data network by means of the same protocol. The use of a plurality of protocols is also possible that are available for the communication with the camera modules, wherein a suitable protocol is selected in each case that is preferably mastered by the transmitting and the receiving camera module. Advantageously, no protocol conversion is thus necessary. The same protocol or the same protocols may be protocols from the OSI layers 3, 4, 5, 6 and/or 7. For example, TCP (Transmission Control Protocol) and/or UDP (User Datagram Protocol) may be used as the transport protocol. Furthermore, RTP (Real-Time Transport Protocol) may be used, in particular for real-time critical data.

Different camera modules may use the same protocol for transmitting data via the data network, wherein the physical layer (OSI Layer 1) and/or the data link layer (OSI Layer 2) may, however, be different. For example, optical waveguides (e.g. from 10 Gbit/s onward) may be used for connections with a high data throughput; copper cables may be used for other connections.

Furthermore, the format of the data which the camera modules use for the transmission via the data network may likewise be uniform. JSON (JavaScript Object Notation) or XML (Extensible Markup Language) may e.g. be used for additional information (such as metadata) in the data. The additional information together with the actual image data may be stored in a container file, for example, in a Material Exchange Format (MXF). A uniform data format has the advantage that each camera module may process the data of the other camera modules at least to the extent that is necessary for the function of the respective module.

In accordance with a further embodiment, at least one connection between the distribution unit and one of the camera modules is established by means of a copper cable. The copper cable may, for example, be an Ethernet cable with a maximum transmission rate of e.g. 1 Gbit or 10 Gbit. Alternatively or additionally, at least one connection between the distribution unit and one of the camera modules may be established by means of an optical waveguide. As already indicated above, a fiber optic cable or a fiber optic connection with a transmission rate of e.g. 10 Gbit, 100 Gbit, 200 Gbit or 400 Gbit may be used.

In accordance with a further embodiment, the camera is configured to achieve a synchronization of the camera modules by means of a time synchronization, in particular by means of the Precision Time Protocol (PTP) or by Time-Sensitive Networking (TSN). It is important for the function of the camera that actions of the individual camera modules are coordinated with one another in time. Due to the synchronization by means of PTP, a synchronization with an accuracy in the range of microseconds, when executed by means of hardware even an accuracy in the range of nanoseconds, may be achieved. When using PTP, the delays in the transmission via the data network are determined so that an internal time base of the camera modules and the distribution unit may be adapted to one another. It is understood that other methods of the time synchronization of the camera modules may also be used.

Furthermore, when using a real-time capable fieldbus, the time synchronization may be inherent to the data network.

In accordance with a further embodiment, the power supply of the camera modules may at least partly take place by means of the data network, for example, by means of Power over Ethernet (PoE). The network cables that are anyway required for connecting the camera modules may then be used not only for the data transport but also for the power supply. In this way, the cabling effort in the camera may be saved so that the camera may again be made smaller and more compact.

In accordance with a further embodiment, the camera has a central unit having a separate housing, wherein the distribution unit is arranged in the central unit. Furthermore, only some of the camera modules (and thus also of the functional modules) may be arranged in or at the housing of the central unit. For example, the image acquisition module may be arranged in the housing of the central unit. Other camera modules may be provided outside and/or spaced apart from the housing of the central unit. For example, the operating module may be connected separately, and in particular only via a network cable, to the central unit. The part of the camera that then e.g. has to be carried or moved during film recordings may thus be smaller and thereby more manageable.

It is, however, generally to be understood that any desired functional modules and/or camera modules may be arranged at or in the central unit. A flexible configuration of the camera may be achieved in this manner.

In accordance with a further embodiment, one or more of the camera modules have a separate module housing, wherein the module housings are in particular fastened to the housing of the central unit. Due to the separate module housings, a conversion of the camera is allowed in a simple manner. It is understood that the module housings do not necessarily have to be fastened to the housing of the central unit, but may e.g. be connected separately, and in particular only via cables of the data network, to the housing of the central unit.

In accordance with a further embodiment, the camera has at least a further one or more of the following camera modules:
a lens recording module that allows the control of a focus motor and/or of an aperture motor;
an audio module for inputting and/or outputting sound signals;
a camera positioning module that detects a spatial position of the camera and in particular of the image acquisition module;
a distance measurement module that determines distances between the image acquisition module and objects to be recorded;
a memory module that stores camera images acquired by the image acquisition module;
a playback module that plays back stored camera images;
a processor module that processes and/or modifies camera images;
a radio module that provides a radio interface for accessories;
a conversion module that converts analog and/or digital signals for the transmission by means of the data network.

The further camera module(s) may likewise communicate and exchange data with the other camera modules via the data network and the distribution unit.

The camera positioning module may be a module that determines the position and/or orientation of the camera in space and that provides the data determined in this manner to other camera modules via the data network. The camera positioning module may detect the spatial position by means of GPS (Global Positioning System) and/or inertial sensors.

The memory module may be a recorder in the data network that stores the camera images. The playback module may play back stored camera images, for example, on a display. Alternatively, the playback module may play out the stored camera images as a stream into the network so that the stored camera images may, for example, be output on a display module. The memory module may have fixedly installed storage media and/or removable media. In general, the memory module may, for example, be implemented in a cloud or on a server on the film set so that the storage may take place in the cloud or on the server. A plurality of recording modules may be present in the camera so that different recording functions may be combined in order, for example, to create a plurality of copies of the image data.

The processor module may in particular perform calculations on the camera images, for example, to linearize the camera images, to correct artifacts and errors and/or to stabilize images. The camera images may also be provided with additional information such as metadata and sound, may be compressed and/or may be encoded. However, the processor module may also process audio data and/or metadata. A plurality of processor modules may also e.g. be connected to one another via the data network of the camera to combine the processing resources of the processor modules from different camera modules or to distribute the resulting workload to the processor modules.

The radio module preferably converts data and commands received from other camera modules or accessories (e.g. via WLAN or by means of another radio protocol) such that they may be transmitted, in particular bidirectionally, to other camera modules via the data network. The radio module may, for example, accordingly implement the protocol and/or the data format in each case.

The conversion module in particular also allows a bidirectional data transmission and, for example, converts SDI signals, L-bus signals, R-S signals, coaxial signals, analog audio signals and the like.

The lens recording module may also be designated as the lens control module and controls the lens connected to the camera and provides information about the lens and its settings. The lens recording module may e.g. comprise electric motors for changing the focal plane, for changing the aperture and/or the zoom and/or may be configured to control lenses with integrated motors. The lens recording module may furthermore receive control information from internal or external camera modules and/or may transmit status information to these camera modules.

The audio module may acquire audio signals, process the audio signals and provide the audio signals for the playback at external and internal interfaces. The audio module may e.g. connect audio interfaces to the data network of the camera. The main application of the audio module may be the acquisition and processing of audio signals for the sound recording. However, the audio module may also be part of an intercom system by which voice messages may be transmitted between different people (e.g. camera operators).

Furthermore, the camera may comprise a connection module that connects the data network of the camera to an external network, for example by means of a fiber optic connection, in particular to a studio infrastructure and/or an OB van.

Furthermore, the camera may comprise a power supply module. The power supply module may, for example, have a plurality of rechargeable batteries/batteries, wherein the power supply module may, for example, communicate a remaining battery capacity and/or a maximum available power of the power supply module to the other camera modules via the data network.

It is understood that any desired further and/or future modules may also be integrated into the camera as camera modules.

A plurality of display modules may in particular e.g. be connected to the data network and may thus be integrated into the camera. The display modules may e.g. receive the same image data via the data network. The display modules may have an image processing unit that carries out a modification to the image data before the image data are displayed. Due to the modification, a false color representation may e.g. be performed on one display module, but a color change may be performed on another display module. Due to the image processing units in the display modules, the camera or, more precisely, the image acquisition module advantageously does not have to provide different image data. The computing requirements for the image acquisition module or a processor module may thus decrease, whereby the camera may be more energy-efficient, smaller and/or more compact.

A further subject of the invention is an operating method for a modular electronic camera, and in particular a distributed electronic camera. The camera has an image acquisition module comprising an image sensor and an image processing unit coupled to the image sensor, a first functional module, for example an operating module for controlling and/or configuring the camera, and/or a second functional module, for example a display module for displaying camera images acquired by the image sensor. The image acquisition module and the first and second functional module (i.e., for example, the operating module and the display module) are camera modules. The operating method is characterized in that the image acquisition module and the first and second functional module are connected to one another by means of a data network, with the data network having a distribution unit, with the distribution unit receiving data via the data network from the camera modules and forwarding data from one of the camera modules to at least one of the other camera modules.

In accordance with an embodiment of the operating method, the camera is coupled to a second camera via the data network. In this respect, the (first) camera uses at least one camera module of the second camera. The first camera may, for example, use the operating module and/or the image acquisition module of the second camera so that the first camera may be controlled and/or configured via the operating module of the second camera. Alternatively, the first camera may also e.g. outsource calculation tasks to a processor module of the second camera. Due to the connection of the two cameras, a splitting and a common use of the resources of the two cameras among one another is thus possible. Generally speaking, the second camera receives data and/or commands from a camera module of the first camera and/or forwards data and/or commands to a camera module of the first camera.

Furthermore, it is possible for two cameras to record the same scene (e.g. via a beam splitter), wherein the dynamic range or the image capture rate (frame rate) may be increased or doubled by connecting the two cameras.

The audio modules of the two cameras may also be coupled to one another in order e.g. to achieve a better sound quality. Alternatively or additionally, a camera without its own audio module may also record the audio signal of other cameras.

Likewise, a camera comprising a radio module may use the radio module of the second camera to increase a signal quality and/or a data rate by radio. Finally, a camera without a radio module may also use the radio module of the second camera to allow the connection of accessories by radio.

As already stated above, an operating module of the second camera may therefore be used to control and/or to configure the first camera. Alternatively or additionally, a display module of the first camera may be used to display camera images of the second camera.

In accordance with a further embodiment of the operating method, the image acquisition module of the first camera and the image acquisition module of the second camera are synchronized via the data network. Such synchronized recordings may, for example, be required for creating three-dimensional (3D) images.

Finally, the invention relates to a camera module for connecting to a modular camera, in particular to a modular camera as described herein, wherein the camera module may be connected to the modular camera by means of a data network, wherein the camera module is configured to receive data via the data network from at least one other camera module and to transmit data to at least one of the other camera modules.

The statements on the camera in accordance with the invention apply accordingly to the operating method in accordance with the invention and to the camera module in accordance with the invention. This in particular applies with respect to advantages and embodiments. It is understood that the embodiments mentioned herein may be combined with one another, unless explicitly stated otherwise.

The invention will be described purely by way of example with reference to the drawings in the following. In this respect, the modular camera will first be generally described. Subsequently, the device profiles and the possibility of monitoring on different display modules will be looked at.

There are shown:

FIG. 1 schematically, a modular electronic camera comprising a distribution unit;

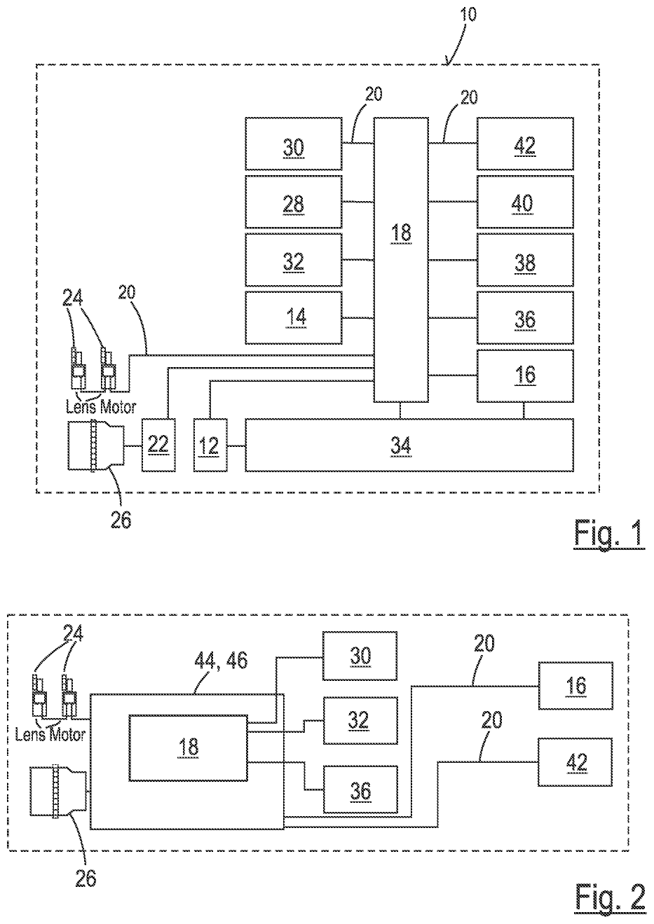

FIG. 2 schematically, the spatial arrangement of the camera modules of the electronic camera of FIG. 1;

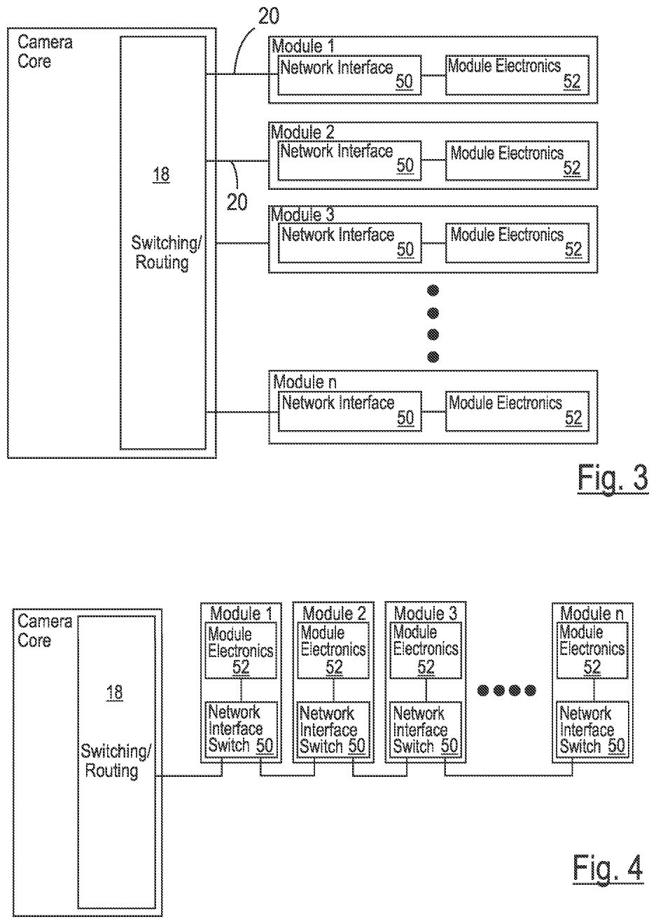

FIG. 3 a schematic view of camera modules in accordance with a first embodiment that are connected to a data network;

FIG. 4 schematically, a view of camera modules in accordance with a second embodiment that are connected to a data network;

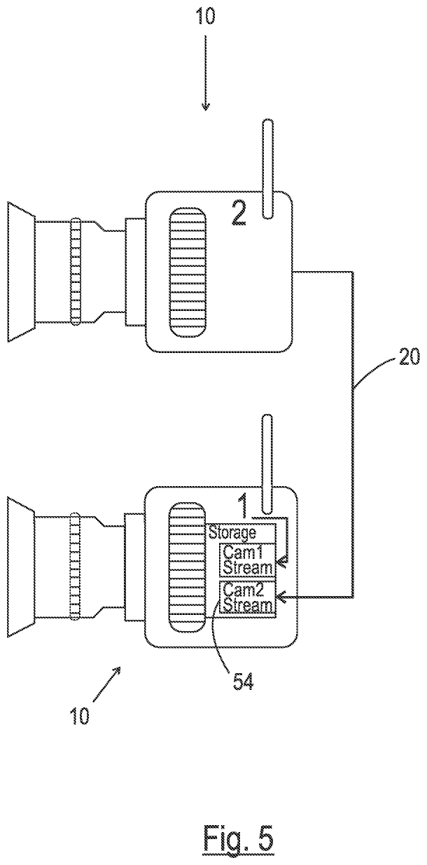

FIG. 5 the coupling of two cameras via a data network;

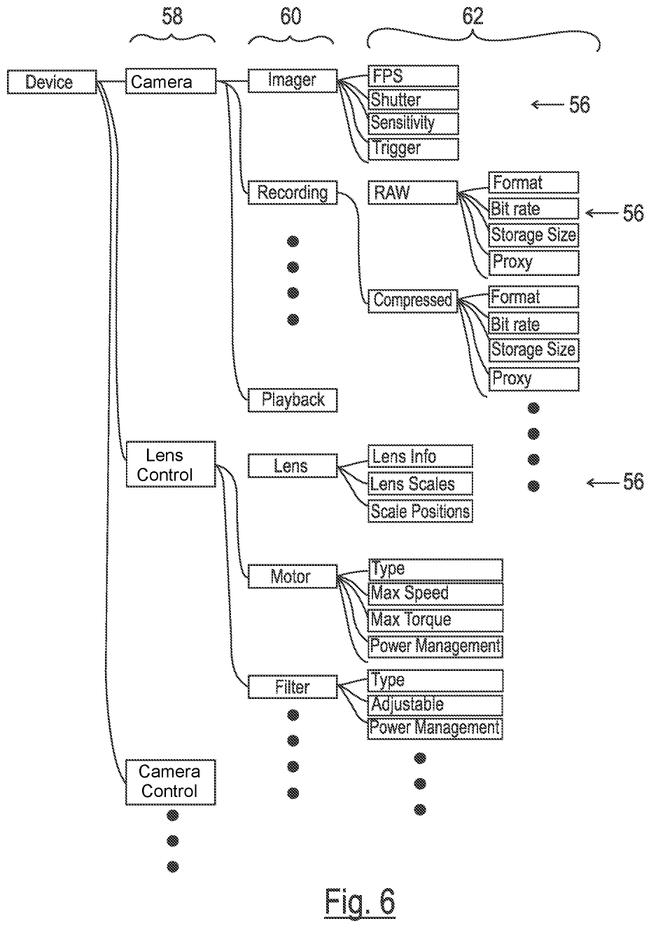

FIG. 6 schematically, the division of device profiles into device class and information about the functional scope; and

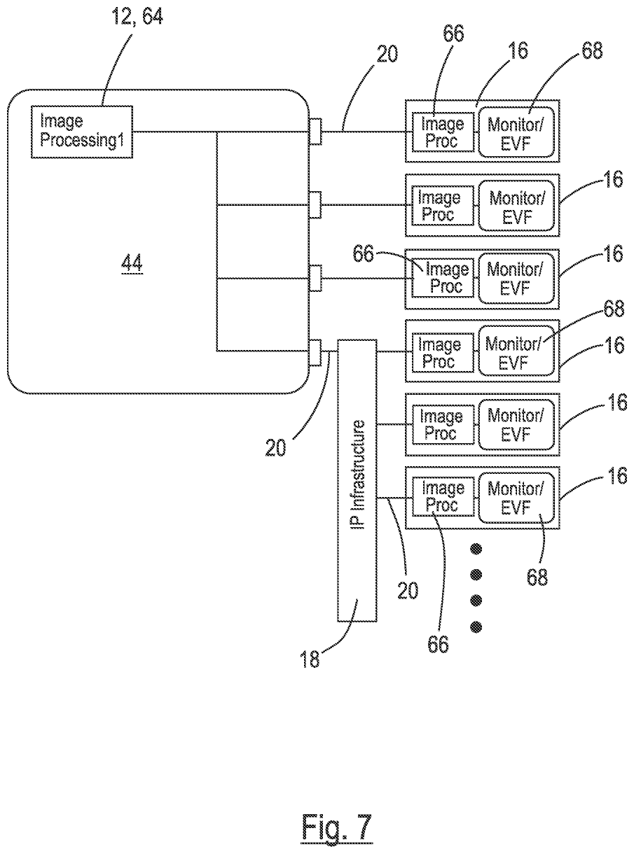

FIG. 7 schematically, display modules that are coupled via a data network and that receive image data from a transmission module.

FIG. 1 shows a camera 10 comprising an image acquisition module 12 that has an image sensor and an image processing unit. The camera 10 further comprises an operating module 14 that serves to control and/or to configure the camera 10.

The camera 10 furthermore comprises a display module 16, e.g. a viewfinder, that displays camera images acquired by the image sensor.

The image acquisition module 12, the operating module 14 and the display module 16 are camera modules and are each coupled to a distribution unit configured as a switch 18 via Ethernet connections 20. The operating module 14 and the display module 16 may also be designated as the first and the second functional module.

The camera 10 comprises even further camera modules, namely a lens recording module 22, wherein the lens recording module 22 is divided into a plurality of part modules and has motors 24 for adjusting a lens 26 and a motor control 28 for controlling the motors 24. The motors 24, the lens 26 and the motor control 28 could alternatively also be considered as separate camera modules.

Further camera modules of the camera 10 are a camera positioning module 30, an audio module 32, a processor module 34, a conversion module 36, a radio module 38 and a connection module 40. Finally, the camera 10 may also comprise a second display module 42.

All of the camera modules 12, 14, 16, 22, 30, 32, 34, 36, 38, 40, 42 are coupled to the switch 18 via Ethernet connections 20. The Ethernet connections 20 may be configured as copper cables or also as optical waveguides.

The switch 18 in each case receives data from the camera modules and forwards the data to one or more other camera modules. In this respect, the camera modules use the same data network, namely a data network that is built up from the switch 18 and the Ethernet connections 20 and that transmits data between the camera modules. The data network serves as a data interface between the camera modules. Through a simple connection to the data network, other and/or additional camera modules may thus be integrated into the camera 10.

FIG. 2 shows the spatial arrangement of the camera modules of the camera 10 of FIG. 1. As shown in FIG. 2, the camera 10 comprises a central unit 44 that has a separate housing 46. The switch 18 and all the camera modules not shown outside the central unit 44 are arranged in the central unit 44. The camera positioning module 30, the audio module 32 and the conversion module 36 are arranged outside the housing 46 of the central unit 44. These modules may be mechanically attached to the housing 46 of the central unit 44. In contrast, the display module 16 and the second display module 42 are spaced apart and are attached outside the housing 46 and are in particular only connected via the Ethernet connections 20 to the central unit 44 and thus to the switch 18. Due to the outsourcing of camera modules, the part of the camera 10 that usually has to be moved may be designed as smaller and more manageable.

FIG. 3 and FIG. 4 show two different embodiments of the configuration of the data network. In particular from FIG. 3 and FIG. 4 onward, camera modules are generally shown with the reference numeral 48. In accordance with the first embodiment of FIG. 3, the camera modules 48 each have their own network interface 50, i.e. their own hardware for connecting an Ethernet connection 20. The camera modules 48 furthermore each comprise module electronics 52 that control the communication via the Ethernet connection 20 and that e.g. comprise a protocol stack. In accordance with the embodiment of FIG. 3, the camera modules 48 are each directly connected to the switch 18 via an Ethernet connection 20. In contrast, the camera modules 48 in accordance with the second embodiment of FIG. 4 each comprise the functionality of a hub or a switch in their network interface 50 and may accordingly, as shown in FIG. 4, be connected in the form of a chain. In the embodiment of FIG. 4, only one camera module 48 is directly connected to the switch 18 via an Ethernet connection 20. This directly connected camera module 48 comprises a further Ethernet connection 20 that connects the next camera module 48. Thus, the data of the next camera modules 48 first run via the camera module 48 directly connected to the switch 18 and are then forwarded to the switch 18, if necessary.

FIG. 5 shows the connection of two cameras 10 via an Ethernet connection 20. Due to the Ethernet connection 20 between the two cameras 10, the data networks of the cameras 10 may be connected to one another so that the camera modules 48 of the one camera 10 may access the camera modules 48 of the other camera 10. For example, the camera 10 shown at the bottom in FIG. 5 may have a memory module 54 that is used by both cameras 10 to store the generated image data.

It can be seen that a great flexibility in the structure of the camera 10 may be achieved by the modular design of the camera 10 by means of the camera modules 48. Furthermore, the camera 10 may be kept small and light for the operation so that advantages result on the film set. The data network may furthermore be easily coupled to further cameras to enable an outsourcing of functionalities from one camera 10 to another to allow a synchronization of cameras 10 for 3D recordings or to enable a control of a plurality of cameras 10 from a central point.

Device profiles of camera modules 48 are schematically shown in FIG. 6. The device profiles 56 each comprise a device class 58, i.e., for example, “camera”, “lens control” or “camera control”. The device classes 58 each also comprise subclasses 60 that define the device class in more detail. Information about the functional scope 62 is specified for each device class 58 and/or for each subclass 60, said information, for example, reproducing the capabilities of a camera, e.g. whether the camera can handle a RAW format or a compressed format.

If it is now assumed by way of example for the camera 10 shown in FIG. 2 that the camera positioning module 30 and the audio module 32 are connected to the camera 10, a connection to the data network or the data interface of the camera is first established by means of the Ethernet connection 20 for the camera positioning module 30 and the audio module 32. A control unit (not shown) of the camera 10, which is, for example, arranged in the central unit 44 or which may be part of the processor module 34, effects the transmission of the device profiles 56 from the camera positioning module 30 and from the audio module 32 to the camera 10 after the connection has been established. The transmission of the device profiles may, for example, take place in the form of an XML file and/or a JSON file.

After receiving the device profiles 56, the device profiles are evaluated and operating parameters of the camera 10 are adapted based on the device profiles 56. Thus, a transmission of audio signals to the audio module 32 may, for example, be activated. Furthermore, the position information output by the camera positioning module 30 may, for example, be forwarded to the processor module 34. To set up such data connections, the operating parameters of the camera 10 are changed accordingly.

Finally, in FIG. 7, the display of different variants of camera images is shown. FIG. 7 shows a transmission module 64 that is part of the image acquisition module 12. The transmission module 64 is connected to a plurality of display modules 16 via the data network, i.e. via Ethernet connections 20. A portion of the display modules 16 is directly connected to the central unit 44. Another portion of the display modules 16 is connected to the transmission module 64 via a further switch 18. Further display modules 16 may in particular be connected via the further switch 18 so that the number of display modules may be easily scaled.

Each of the display modules comprises an image processing unit 66.

During the operation of the camera 10, image data generated by the image acquisition module 12 are transmitted from the transmission module 64 to the display modules 16, wherein the transmission module 64 only performs a scaling and/or a compression of the image data. The image data are received from the display modules 16 and are in each case modified by means of the image processing unit 66 before the image data are displayed on displays 68 of the display modules 16. For example, a color grading, a false color representation, the display of overlays and the like may be performed by the image processing units 66.

Due to the network-based playout of the image data, it is possible to simultaneously provide different display modules 16 with image data without placing a high load on the computing resources of the camera 10. A flexible design of the monitoring for different application purposes is thus made possible.

### REFERENCE NUMERAL LIST

10 camera
12 image acquisition module
14 operating module
16 display module
18 switch
20 Ethernet connection
22 lens recording module
24 motor
26 lens
28 motor control
30 camera positioning module
32 audio module
34 processor module
36 conversion module
38 radio module
40 connection module
42 second display module
44 central unit
46 housing
48 camera module
50 network interface
52 module electronics
54 memory module
56 device profile
58 device class
60 subclass
62 information about the functional scope
64 transmission module
66 image processing unit
68 display

1. A modular electronic camera, comprising
an image acquisition module comprising an image sensor and an image processing unit coupled to the image sensor,
a first functional module, and
a second functional module,
wherein the image acquisition module and the first and second functional module are camera modules,
wherein the image acquisition module and the first and second functional module are connected to one another by means of a data network, with the data network having a distribution unit that is configured to receive data via the data network from the camera modules and to forward data from one of the camera modules to at least one of the other camera modules.

2. The camera in accordance with claim 1,
wherein the first functional module is an operating module for controlling and/or configuring the camera.

3. The camera in accordance with claim 1,
wherein the second functional module is a display module for displaying camera images acquired by the image sensor.

4. The camera in accordance with claim 1,
wherein the distribution unit comprises a switch, a hub, a router and/or a gateway.

5. The camera in accordance with claim 1,
wherein the distribution unit is designed in a cascaded manner and/or from part units.

6. The camera in accordance with claim 1,
wherein the distribution unit is configured to recognize camera modules connected to the distribution unit via the data network and to perform the forwarding of data of the camera modules based on the connected camera modules.

7. The camera in accordance with claim 6,
wherein at least one of the camera modules, in particular after the connection to the data network, transmits a device profile via the data network, wherein the device profile comprises a device class of the camera module and information about the functional scope of the camera module.

8. The camera in accordance with claim 7,
wherein said at least one of the camera modules is configured to transmit the device profile after the connection to the data network.

9. The camera in accordance with claim 1,
wherein each of the camera modules is configured as an independent network component.

10. The camera in accordance with claim 1,
wherein the data network comprises an Ethernet network, a fieldbus network or a non-IP network or is such a network.

11. The camera in accordance with claim 1,
wherein the distribution unit is configured to communicate with the camera modules via the data network by means of the same protocol.

12. The camera in accordance with claim 1,
wherein the camera is configured to achieve a synchronization of the camera modules by means of a time synchronization.

13. The camera in accordance with claim 12,
wherein the camera is configured to achieve the synchronization of the camera modules by means of the Precision Time Protocol or by Time-Sensitive Networking.

14. The camera in accordance with claim 1,
wherein the camera has a central unit having a separate housing, wherein the distribution unit is arranged in the central unit.

15. The camera in accordance with claim 14,
wherein only some of the camera modules are arranged in and/or at the housing of the central unit.

16. The camera in accordance with claim 14,
wherein one or more of the camera modules have a separate module housing.

17. The camera in accordance with claim 16,
wherein the module housings are fastened to the housing of the central unit.

18. The camera in accordance with claim 1,
wherein the camera has at least a further one of the following camera modules:
a lens recording module that allows the control of a focus motor and/or of an aperture motor;
an audio module for inputting and/or outputting sound signals;
a camera positioning module that detects a spatial position of the camera;
a distance measurement module that determines distances between the image acquisition module and objects to be recorded.

19. The camera in accordance with claim 1,
wherein the camera has at least a further one of the following camera modules:
a memory module that stores camera images acquired by the image acquisition module;
a playback module that plays back stored camera images;
a processor module that processes and/or modifies camera images;
a radio module that provides a radio interface for accessories;
a conversion module that converts analog and/or digital signals for the transmission by means of the data network.

20. An operating method for a modular electronic camera, comprising an image acquisition module comprising
an image sensor and an image processing unit coupled to the image sensor,
a first functional module, and
a second functional module,
wherein the image acquisition module and the first and second functional module are camera modules,
wherein, in accordance with the method,
the image acquisition module and the first and second functional module are connected to one another by means of a data network, with the data network having a distribution unit, with the distribution unit receiving data via the data network from the camera modules and forwarding data from one of the camera modules to at least one of the other camera modules.

21. The operating method in accordance with claim 20,
wherein the camera is coupled to a second camera via the data network and the camera uses at least one camera module of the second camera.

22. The operating method in accordance with claim 21,
wherein an operating module of the second camera is used to control and/or to configure the camera.

23. The operating method in accordance with claim 21,
wherein a display module of the camera is used to display camera images of the second camera.

24. The operating method in accordance with claim 21,
wherein the image acquisition module of the camera and the image acquisition module of the second camera are synchronized via the data network.

25. A camera module for connecting to a modular camera,
wherein the camera module can be connected to the modular camera by means of a data network, wherein the camera module is configured to receive data via the data network from at least one other camera module and to transmit data to at least one of the other camera modules.
